(19) United States
(12) Patent Application Publication
(10) Pub. No.: US 2017/0095839 A1
(43) Pub. Date: Apr. 6, 2017

(54) SORTING FACILITY FOR ITEMS TO BE SORTED WITH DECENTRALIZED FUNCTIONAL UNITS FOR THE DETECTION OF FAULT STATES

(71) Applicant: SIEMENS AKTIENGESELLSCHAFT, MUENCHEN (DE)

(72) Inventors: ALFRED GLUCH, WUPPERTAL (DE); NORBERT HOOS, GROSSENSEEBACH (DE); HEINZ-GERD MOSCHUERING, EMMERICH (DE); JOHANNES RANFT, NUERNBERG (DE); MARKUS SCHMID, NUERTINGEN (DE); ULRICH SUESS, CHEMNITZ (DE)

(21) Appl. No.: 15/285,683

(22) Filed: Oct. 5, 2016

(30) Foreign Application Priority Data
Oct. 5, 2015 (EP) 15188362.6

(51) Int. Cl. B07C 3/00; G01M 99/00

(52) U.S. Cl. CPC B07C 3/006; G01M 99/008

(57) ABSTRACT

A sorting facility for items to be sorted, such as postal items, parcels, packages, baggage, suitcases, etc., includes carrying elements, conveyor paths at which the carrying elements are transported to target positions, to empty the items from a carrying element into a target position, a facility controller controlling movement of the carrying elements along the conveyor paths and emptying at the target positions, and a decentralized functional unit receiving process information regarding the conveyor paths and/or the carrying elements and, by comparison with nominal process information, detecting deviation from the nominal process information and reporting it to the controller. The functional units, which monitor the facility or surroundings, have computer-aided intelligence detecting and reporting deviations to the controller. Faults and/or impending faults, which can only be detected with difficulty or not at all, even in sorting facilities, are detected reliably and be reported timely to the controller.

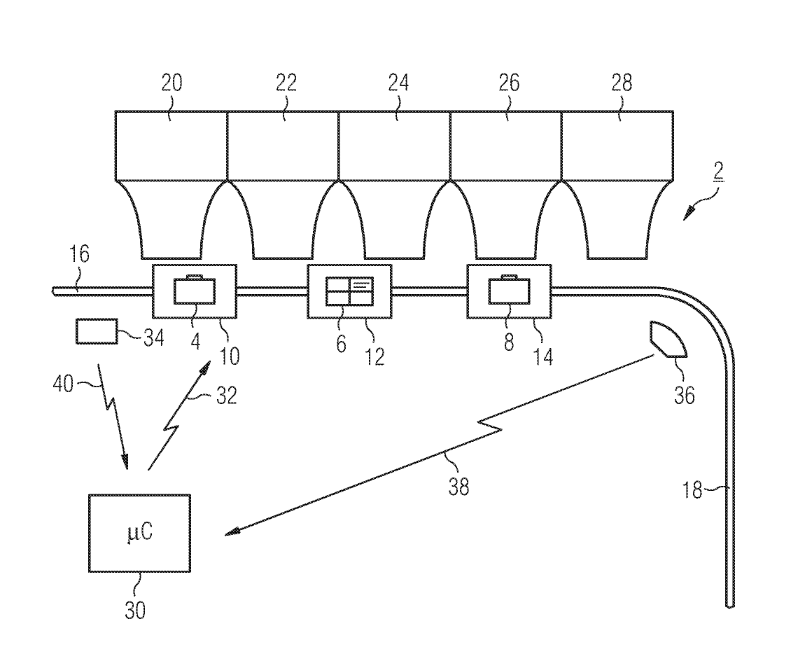

### CROSS-REFERENCE TO RELATED APPLICATION

This application claims the priority, under 35 U.S.C. §119, of European Patent Application EP 15188362.6, filed Oct. 5, 2015; the prior application is herewith incorporated by reference in its entirety.

### BACKGROUND OF THE INVENTION

Field of the Invention

The invention relates to facilities such as e.g. sorting facilities for items to be sorted, for example postal items, parcels, packages, baggage items, suitcases and the like.

In distribution and sorting centers for postal items and/or piece goods (packages, suitcases and the like), which are generally referred to in the following as items to be sorted, the items are sorted according to predefinable criteria and delivered to a target position stored in a facility controller by using at least one sorting facility. In that case, the sorting facility as a rule has a structure which is optimized for the items to be sorted in each case. While postal items are generally conducted between conveyor belts and gates to the respective target position while standing on a longitudinal edge, for packages in airports, sorting facilities with appropriately larger dimensions, such as carousel sorters, tilt-tray sorters and cross-belt sorters, are used for transporting and for sorting the items to be sorted to the respective target position.

In all of those sorting facilities, in addition to a generally computer-aided facility controller, sophisticated mechanical transportation devices for the items to be sorted are used, for which there is a great need for the ability to promptly identify and then rectify existing faults and/or arising faults, before they can result in greater interruptions to the sorting process, which is generally time-critical.

Typically, at present, technicians who are sent into the sorting facility for this purpose pass along the conveyor path and examine it for faults. In addition, sensors such as light barriers and the like are present, which detect any blockages of the items to be sorted and/or other sorting irregularities and/or degrees of fullness at the target positions locally and report them to the respective facility controller which is responsible. Detecting faults at parts of the sorting facility and triggering the appropriate corrective actions does, however, frequently remain subject to the experience of the technician as a result. Since sorting facilities of that kind are, however, complex systems and there is frequently a high level of noise while the facility is running, it is not always possible for the technician to actually detect all possible fault states by optical and/or acoustic inspection.

### SUMMARY OF THE INVENTION

It is accordingly an object of the invention to provide a sorting facility for items to be sorted with decentralized functional units for the detection of fault states, which overcomes the hereinafore-mentioned disadvantages of the heretofore-known facilities of this general type and with which existing faults and/or arising faults at parts of the facility can be detected in good time and reported to the facility controller.

With the foregoing and other objects in view there is provided, in accordance with the invention, a sorting facility for items to be sorted, such as, for instance, postal items, parcels, packages, baggage items, suitcases and the like, comprising:
a) a number of carrying elements for the items to be sorted;
b) a number of conveyor paths, on which and/or along which the carrying elements can be transported to target positions, in order to empty the items to be sorted from the respective carrying element into the target position;
c) a facility controller, which controls the movement of the carrying elements along the conveyor paths and the emptying at the target positions; and
d) at least one decentralized functional unit, which receives process information regarding the conveyor paths and/or the carrying elements and, by way of comparison with nominal process information, detects deviation from the nominal process information and reports it to the facility controller.

In this way, it is possible to use the decentralized functional units as a type of monitor for a particular part of the facility and/or a particular region of the facility and/or surroundings. The functional units have an appropriate computer-aided intelligence in order to detect the deviations and report them to the facility controller. This procedure therefore makes it possible to detect faults and/or impending faults, which a technician cannot reliably detect or can only detect with difficulty, even in the harsh environment of the running sorting facility, and thus be able to report them to the facility controller in good time.

Typically, the process information can be of the optical and/or acoustic type. Accordingly, the decentralized functional unit can include a microphone and/or a camera, in order to record the current environmental situation. Fundamentally, however, other sensors such as acceleration sensors, vibration sensors, piezoelectric sensors, temperature sensors and the like are also conceivable.

In an advantageous embodiment of the present invention, the decentralized functional units can have nominal process information stored in the form of images and/or frequency spectra. This means that the decentralized functional unit can be configured according to the desired operational and monitoring task as required.

In a further advantageous embodiment of the present invention, the decentralized functional unit can include an evaluation unit, which examines the captured process information in the form of an image comparison and/or a Fourier analysis. The nominal process information appropriately stored as images and/or Fourier spectra thus form the basis of the actual comparison.

In complex facility systems, which also include sorting facilities, there is also the requirement of limiting the quantity of transmitted process data to the greatest extent possible. The decentralized functional unit can contribute to this if it has a catalogue of collateral environmental information and detects such environmental information in the process information as part of the evaluation of the process information. In this way, a deviation of the process information from the nominal process information can then indeed be ascertained. This deviation, however, is not transmitted to the facility controller as a fault notification, if it is found in the catalogue of the collateral environmental information. Examples of this include the beep of a fork-lift truck, a break siren, general warning signals and alerts and the like.

Furthermore, there can be provision in an advantageous embodiment of the invention for the decentralized functional unit to have a catalogue of process information indicating a fault, wherein if a deviation of the captured process information from the nominal process information is detected, this deviation is compared with the content of the catalogue of the process information indicating a fault. In this way it is possible to allocate, for example, the occurrence of the deviation within a particular frequency range to a faulty ball bearing or similar and thus to already report this fault accordingly. Accordingly, if the detected deviation matches an item of process information indicating a fault, the fault to which this match refers is transmitted to the facility controller.

Other features which are considered as characteristic for the invention are set forth in the appended claims.

Although the invention is illustrated and described herein as embodied in a sorting facility for items to be sorted with decentralized functional units for the detection of fault states, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWING

The figure of the drawing is a diagrammatic, top-plan view of a sorting facility for items to be sorted.

### DETAILED DESCRIPTION OF THE INVENTION

Referring now in detail to the single figure of the drawing, there is seen a diagrammatic view from above of a section of a sorting facility 2 for items to be sorted, in this case suitcases 4, 8 and a package 6. A sorting facility 2 of this kind is located, for example, in an airport or a parcel center.

The sorting facility 2 for items to be sorted, such as postal items, parcels, packages 6, baggage items, suitcases 4, 8 and the like, includes a number of transport trolleys 10 to 14 (carrying elements) for the suitcases 4, 8 and packages 6. The transport trolleys 10 to 14 can have tilt-tray elements or cross-belt elements which are not shown in further detail herein. Furthermore, the sorting facility 2 includes a number of conveyor paths 16, 18, on which and/or along which the transport trolleys 10 to 14 can be transported to target positions 20 to 28, in order to empty the items to be sorted from the respective transport trolley 10 to 14 into the proper target position 20 to 28 according to a sorting target. Furthermore, there is provision for a facility controller 30, which controls the movement of the transport trolleys 10 to 14 along the conveyor paths 16, 18 and the emptying into the target positions 20 to 28. In this case, there can be provision, for example, for the facility controller to transmit a signal which triggers the emptying of a suitcase 4, 8 into one of the target positions 20 to 28 by way of a wireless communication 32 to the transport trolleys 10 to 14. The transport trolley 10 to 14 can then, for example, automatically tilt the tilt-tray element in order to tip the suitcase 4, 8 or it can drive the cross-band element to pass on the suitcase 4, 8. It is likewise also conceivable for a rocker of the transport trolleys 10 to 14 to be guided into a connecting member allocated to the conveyor path 16, 18, in order to tip the suitcase 4, 8 at the desired target position 20 to 28 from the transport trolley 10 to 14 as a result. It should be noted in this case that these procedures follow particular automatic behaviors and therefore can also follow particular patterns which can be predefined and also recognized with regard to an optical and/or acoustic representation.

Furthermore, the sorting facility 2 includes two decentralized functional units 34, 36, which receive process information regarding the conveyor paths 16, 18 and/or the transport trolleys 10 to 14. This process information is acoustic and/or optical process information and is recorded by the decentralized functional units 34 by using microphones and/or cameras (not shown in further detail). Furthermore, acceleration and vibration sensors are also conceivable. By way of comparison with nominal process information, such as the patterns referred to above, the decentralized functional units can detect deviation of the captured process information from the nominal process information and report it to the facility controller 30. In this case, an item of process information can be the tipping height of a tilt-tray element of a transport trolley 10 to 14 achieved when tipping an item to be sorted, for example. Furthermore, the process information can also be the tipping noise of a tilt-tray element and/or the running noise of a transport trolley 10 to 14 on the conveyor path 16, 18. While the achievement of a nominal tipping height can be monitored by using a light barrier or by evaluating a video image, for example, the captured acoustic process information can be subjected to a Fourier analysis and the frequency spectrum detected can be compared with a nominal frequency spectrum. This nominal process information can be stored on the decentralized functional unit 34, 36 in the form of video images and/or frequency spectra, for example. This means that the decentralized functional unit 34, 36 can be configured freely at any time with regard to its intended purpose.

In addition to this important nominal process information, the decentralized functional unit 34, 36 can also further include a catalogue of collateral environmental information. Typically, this collateral environmental information is noise or objective incidents, which are not directly related to the actual process information regarding the sorting process, such as the beep of a fork-lift truck or a warning or break siren and the like. Environmental information of this kind, which is contained in the process information, is detected by way of the evaluation of the process information by a comparison with the collateral process information contained in the catalogue. The deviation from the nominal process information occurring in this way thus does not lead to a notification from the decentralized functional unit 34, 36 to the facility controller 30.

Furthermore, the decentralized functional units 34, 36 can also have a catalogue of process information indicating a fault. Typical entries of this catalogue can, for example, be the frequency spectrum of the noise or the vibrations caused by damage to a ball bearing, which is triggered by a break or an interruption to a rail of the conveyor path 16, 18 or by a flat spot on the wheel of a transport trolley 10 to 14. If such a phenomenon arises in the captured process information, this leads to a detected deviation of the captured process information from the nominal process information. This deviation is then compared with the content of the catalogue of the process information indicating a fault and, if it matches one of these entries, an accordingly allocated fault notification is sent from the decentralized functional unit 34, 36 to the facility controller 30 (e.g. to the server or in the cloud thereof), for example by way of a wireless communication (e.g. WLAN) 38, 40.

Through the use of the two latter measures, the volume of fault notifications can be prefiltered to a very significant degree and thus limited to just the amount necessary, which is very welcome in modern automated industrial facilities, such as in the sorting facility 2 described herein, due to the large number of data to be transmitted and processed.

1. A sorting facility for postal items, parcels, packages, baggage items, suitcases and other items to be sorted, the sorting facility comprising:
a) a plurality of carrying elements for the items to be sorted;
b) a plurality of conveyor paths at least one of on which or along which said carrying elements can be transported to target positions in order to empty the items to be sorted from a respective carrying element into a target position;
c) a facility controller controlling movement of said carrying elements along said conveyor paths and controlling emptying at the target positions; and
d) at least one decentralized functional unit receiving process information regarding at least one of said conveyor paths or said carrying elements, detecting a deviation from nominal process information by comparison with the nominal process information and reporting the deviation to said facility controller.

2. The sorting facility according to claim 1, wherein the process information is at least one of optical or acoustic information.

3. The sorting facility according to claim 1, wherein said at least one decentralized functional unit includes at least one of a microphone or a camera.

4. The sorting facility according to claim 1, wherein said at least one decentralized functional unit stores the nominal process information as at least one of images or frequency spectra.

5. The sorting facility according to claim 1, wherein said at least one decentralized functional unit includes an evaluation unit examining captured process information as at least one of an image comparison or a Fourier analysis.

6. The sorting facility according to claim 1, wherein said at least one decentralized functional unit has a catalogue of collateral environmental information and detects the collateral environmental information in the process information as part of an evaluation of the process information.

7. The sorting facility according to claim 1, wherein said at least one decentralized functional unit has a catalogue of process information indicating a fault, and upon detecting a deviation of captured process information from the nominal process information, the deviation is compared with the content of the catalogue of the process information indicating a fault.

8. The sorting facility according to claim 7, wherein if the detected deviation matches an item of process information indicating a fault, the fault to which the match refers is transmitted to said facility controller.
